(19) United States
(12) Patent Application Publication
(10) Pub. No.: US 2011/0273142 A1
(43) Pub. Date: Nov. 10, 2011

(54) Parallel Boost Unity Power Factor High Power Battery Charger

(76) Inventor: Norman Luwei Jin, Rochester Hills, MI (US)

(21) Appl. No.: 13/101,144

(22) Filed: May 5, 2011

Related U.S. Application Data
(60) Provisional application No. 61/332,682, filed on May 7, 2010.

(51) Int. Cl. H02J 7/10

(52) U.S. Cl. 320/137

(57) ABSTRACT

A high power battery charger includes a full bridge DC/DC converter as its main converter following a low frequency diode rectifier bridge connected to the power grid and followed by a high frequency diode rectifier bridge to charge the battery. Because the battery negates charging voltage less than that of itself, the conduction angle of the charging current dramatically drops when the battery voltage increases. The small conduction angle of the charger raises peak current and lowers power factor. An active power factor correction circuit for a high power charger consists of a boost DC/DC converter placed in conjunction with the main full bridge DC/DC converter. The present invention is a new charger topology that alters the positioning and control of the power factor correction circuit, minimizing the impact of the required additional power factor correction booster on the high power charger's overall efficiency, cost, weight and size.

### BACKGROUND OF INVENTION

The present invention is in the technical field of power electronics. More specifically, the present invention is in the technical field of high power battery chargers. The invention was created with the original objective of charging batteries in plug-in hybrid or battery powered electric vehicles. These vehicles that feature long range per charge and fast charging capabilities necessitate high power battery chargers.

There exist major requirements on such high power battery chargers.
1) The high power level involved in electrical vehicle charging means that the system must operate at high efficiency, as a small decline in efficiency will result in large amounts of power dissipation on the charger itself. This wasted power leads to difficult thermal management, especially in an on-board charger.
2) Unity power factor or power factor close to 1 shall be maintained. A power factor correction (PFC) circuit is required in a charger design. Battery chargers without a PFC circuit have very low power factor.
3) Cost and weight minimization would be strongly desired.

The main challenge to a unity power factor charger is that the voltage of the battery itself nullifies charging voltage less than the current battery voltage. This only allows the battery to be charged in a very narrow time window, called conduction angle, around the peak of the input voltage, which induces harmonic distortions in the battery charger input current, and reduces power factor. Typical methods of achieving unity power factor use a dedicated boost converter (PFC) in series with the main Full Bridge DC/DC converter. The function of such pre-booster is to force the input current to follow the shape of input voltage, so that the battery charger's input impedance is purely resistive. While this does provide excellent power factor, it adds the full loss of the boost converter onto the loss of the charger. This is the result of the boost converter operating continuously independent of input voltage, even if the input voltage is sufficient to charge the battery. This particular implementation of the boost converter reduces the overall efficiency of the system and increases charger cost, for the high power boost converter is large, heavy, and expensive.

This invention presents a new charger design topology in which the boost converter can be dynamically turned on and off based on the instantaneous input voltage, and is only activated when the charging voltage multiplied by the transformer turns ratio slips below the battery voltage. In addition, this new invented design significantly reduces the PFC booster's power requirements to only a fraction of the charger's total power, resulting in a smaller, lighter and less expensive battery charger. The extra power loss due to the added PFC booster is also reduced.

### SUMMARY OF THE INVENTION

The present invention is a design for a high power battery charger that provides high efficiency and retains high power factor.

### BRIEF DESCRIPTION OF THE DRAWINGS

FIG. 1 is a block diagram of a conventional charger design with pre-booster power factor correction.

FIG. 2 is a block diagram of the present invention.

FIG. 3 is a depiction of the input voltage of the battery charger. t=a and t=b are the two points where the grid input voltage equals to the battery voltage.

FIG. 4 is a circuit diagram of the present invention, where D₂ is a bypassing diode when PFC booster is off.

### DETAILED DESCRIPTION OF THE INVENTION

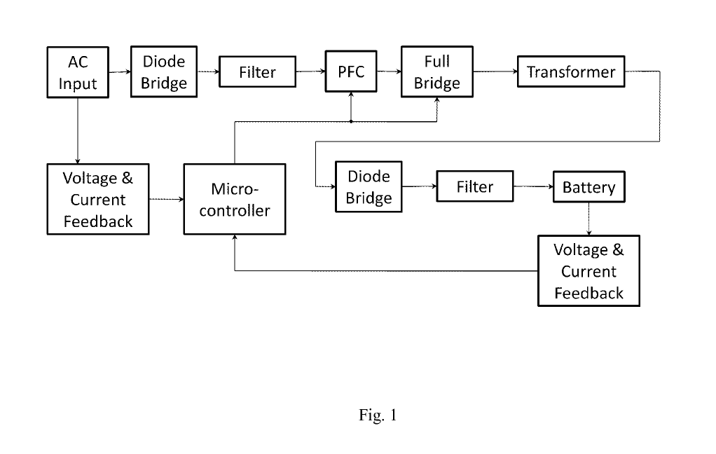

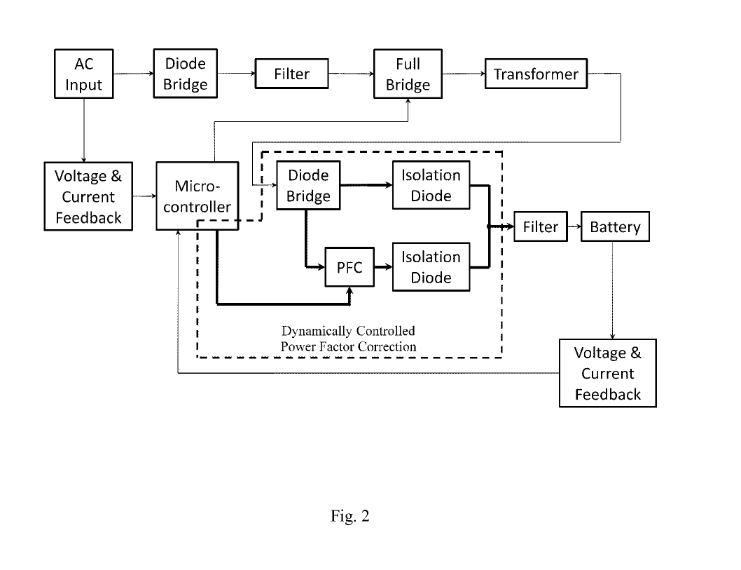

Referring to the invention in more details in FIGS. 1 and 2, note that the main difference between the present invention (FIG. 2) and a typical full power PFC design (FIG. 1) is the location of the power factor correction circuit. The power factor circuit in the present invention is placed in parallel with a bypassing diode, at the output of the full bridge converter. This change allows the dynamic control of whether or not the charging current passes through the power factor correction circuit. Furthermore, the power factor circuit will only be activated when necessary to facilitate charging of the battery, minimizing the amount of power that must pass through the power factor correction circuit.

The present invention brings many production advantages over a typical full power PFC design. Unlike the full power PFC booster in the conventional two stage designs (a PFC booster followed by a full bridge DC/DC converter), the dynamic PFC circuit in this invention, as a partial boost system, would only pass a small portion of the total power of the charger. The PFC circuit would only pass the energy that has insufficient voltage to charge the battery. The PFC circuit suffers less power loss, because less power passes through the circuit. The PFC circuit design proposed by the present invention is also smaller and lighter, with less heat production compared to conventional two stage designs. These are all advantages in the application of the present invention.

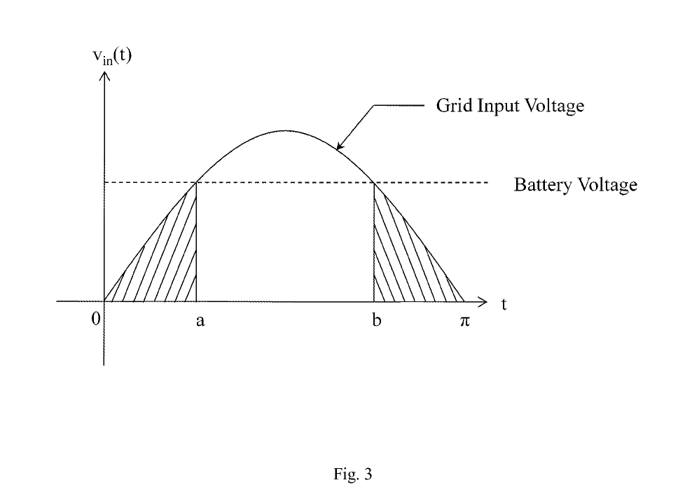

The input of the charger is an AC current from a power grid (FIG. 3). Due to the nature of AC current, the charging voltage fluctuates between a maximum value and zero. The low power factor of a charger without a PFC circuit stems from “dead zones”, where the battery charging current is zero because the charging voltage is lower than the battery voltage. The partial boost converter of the PFC circuit would only activate in these areas. In all of the other area where the input voltage needs no assistance in overcoming the battery voltage, the boost converter would not be in operation. This leads to the reduced power loss that the present invention offers, hence, improves the overall efficiency.

In FIG. 3, the shaded areas represent where the line input does not have enough voltage to charge the battery. The horizontal dashed line is the voltage of the battery. The sine curve represents the input voltage. The PFC circuit would only operate in the shaded sections of the curve, thereby only passing a small fraction of the total power. In the un-shaded regions, the PFC circuit does not need to be active for the battery to be charged. Therefore, that portion of the power does not pass through the additional circuitry of the PFC, facilitating a reduction in power loss.

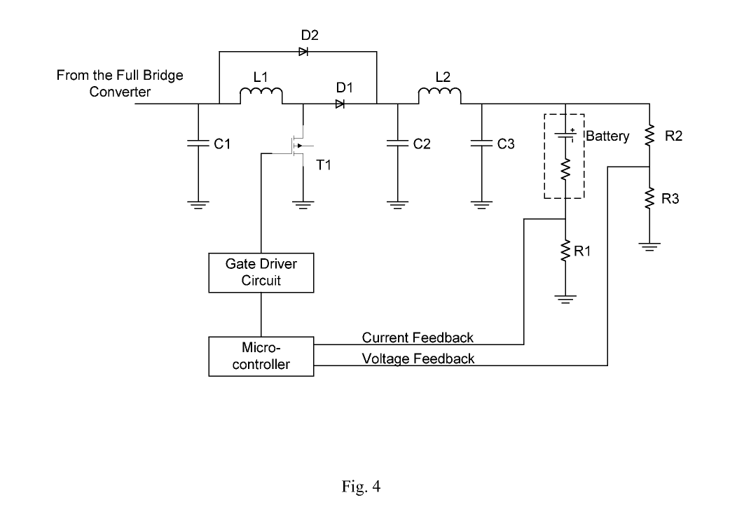

The switching between the direct output of the full bridge converter and the PFC booster could be controlled by software or hardware based on the full bridge converter output voltage. When the full bridge converter output voltage exceeds the battery voltage, the bypassing diode D₂ (FIG. 4) is forward-biased and hence passes the charging current. On the other hand, when the battery voltage exceeds the full bridge converter output voltage, D₂ becomes reverse-biased and the charging current passes through the PFC circuit and the booster diode D₁ to the battery being charged.

This present invention has the following advantages.
1. It provides the same power factor correction as a design with a typical full power PFC circuit.
2. The PFC booster in this invention deals with only a fraction of the charger's total power, greatly reducing booster's power requirements.
3. The reduction in the PFC booster power requirements leads to lower charger cost, lighter weight, smaller size and higher overall charger efficiency.
4. Control of the full bridge converter and the dynamic PFC booster can be implemented through software or hardware.

This new charger topology with the dynamic PFC is particularly suited for on-board plug-in hybrid or battery electric vehicle chargers, due to the reduced cost, weight, size, and the improved efficiency.

This invention claimed:

1. A high power battery charger topology with dynamic Power Factor Correction (PFC) circuitry to achieve unity power factor and reduce power loss

2. The topology described in claim 1 in which the boost converter (PFC circuit) is placed in parallel with a bypassing diode at the output of the main DC/DC converter

3. The topology described in claim 1 in which the boost converter (PFC circuit) processes only a fraction of total charger power delivered to batteries

4. The topology described in claim 1 in which the boost converter (PFC circuit) can be dynamically turned on or off by a control circuit, while the main DC/DC converter stays on

5. The topology described in claim 1 in which the boost converter (PFC circuit) is off when the input power grid voltage is high enough to charge the batteries, while the main DC/DC converter is always on

6. The topology described in claim 1 in which the boost converter (PFC circuit) is on when the input power grid voltage is insufficient to charge the batteries, while the main DC/DC converter is always on

7. The topology described in claim 1 in which the control of the PFC circuit is accomplished through a hardware device

8. The topology described in claim 1 in which the control of the PFC circuit is accomplished through a software program
